(19) United States
(12) Patent Application Publication
(10) Pub. No.: US 2017/0006438 A1
(43) Pub. Date: Jan. 5, 2017

(54) PROCESSING OF MESSAGE BEACONS IN A WIRELESS DEVICE

(71) Applicant: QUALCOMM Incorporated, San Diego, CA (US)

(72) Inventor: Richard Dominic WIETFELDT, San Diego, CA (US)

(21) Appl. No.: 14/788,007

(22) Filed: Jun. 30, 2015

(51) Int. Cl. H04W 4/12; H04W 4/00

(52) U.S. Cl. CPC H04W 4/12; H04W 4/008; H04W 88/06

(57) ABSTRACT

Systems and methods are disclosed for improving the processing of message beacons in a wireless device. The method may include receiving a signal at a first transceiver associated with a first radio access technology (RAT), determining whether the received signal is a message beacon signal, selecting a second transceiver associated with a second RAT for message beacon backhaul transmission based on policy criteria, directing the received signal by diverting the received signal to the selected transceiver in response to a determination that the received signal is a message beacon signal, and transmitting a message beacon backhaul transmission to an external device using the selected transceiver.

### INTRODUCTION

Aspects of this disclosure relate generally to message beacon processing, and more particularly to systems and methods for improving the processing of message beacons in wireless devices.

Message beacons are increasingly used to wirelessly share information with proximate wireless devices. The message beacons may be transmitted by a message beacon device, which may be configured to blanket the surrounding area with message beacons. Once transmitted, the message beacons may be received by any proximate wireless devices that are equipped with the proper transceivers.

A message beacon may typically contain a small amount of data. However, the message beacon may direct the wireless device toward additional information located on an external device, for example, a server in the Internet, or other proximate devices. The additional information may include public service information, advertisements and promotions, location-related data, etc. In order to access this additional information, the wireless device relays the received message beacon to the external device using a backhaul transmission. The external device may be configured to perform a number of tasks, for example, identifying the wireless device, identifying the message beacon, identifying the additional information indicated by the message beacon, determining whether the user of the wireless device is interested in receiving the additional information, providing the wireless device with the additional information, etc. Although each message beacon may contain a relatively small amount of data, it can direct a wireless device that receives the message beacon to a relatively large amount of data, which the wireless device can access by relaying the message beacon to the external device.

However, problems will arise as message beacons proliferate. In particular, the resource consumption associated with message beacon processing will increase. Even if the processing associated with a single message beacon is small, there is a possibility that a wireless device will be inundated by message beacons. As a result, the task of constantly relaying a large number of message beacons to an external device can significantly impact the performance of the wireless device. Accordingly, new solutions are needed to improve message beacon processing in wireless devices.

### SUMMARY

In one aspect, the present disclosure provides a wireless device. The wireless device may comprise, for example, a first transceiver associated with a first radio access technology (RAT), a second transceiver associated with a second RAT, wherein the second transceiver is configured to transmit a message beacon backhaul transmission to an external device, and a connectivity engine configured to select the second transceiver for message beacon backhaul transmission based on policy criteria, wherein the first transceiver is configured to receive a signal, determine whether the received signal is a message beacon signal, and direct the received signal by diverting the received signal to the selected transceiver in response to a determination that the received signal is a message beacon signal.

In another aspect, the present disclosure provides a method for processing a message beacon. The method may comprise, for example, receiving a signal at a first transceiver associated with a first radio access technology RAT, determining whether the received signal is a message beacon signal, selecting a second transceiver associated with a second RAT for message beacon backhaul transmission based on policy criteria, directing the received signal by diverting the received signal to the selected transceiver in response to a determination that the received signal is a message beacon signal, and transmitting a message beacon backhaul transmission to an external device using the selected transceiver.

In yet another aspect, the present disclosure provides an apparatus for processing a message beacon. The apparatus may comprise, for example, means for receiving a signal associated with a first RAT, means for determining whether the received signal is a message beacon signal, means for selecting a second RAT for message beacon backhaul transmission based on policy criteria, means for directing the received signal by diverting the received signal to the selected transceiver in response to a determination that the received signal is a message beacon signal, and means for transmitting a message beacon backhaul transmission to an external device using the selected RAT.

In yet another aspect, the present disclosure provides a non-transitory computer-readable medium comprising code, which, when executed by a processor, causes the processor to perform operations for processing a message beacon. The non-transitory computer-readable medium may comprise, for example, code for receiving a signal associated with a first RAT, code for determining whether the received signal is a message beacon signal, code for selecting a second RAT for message beacon backhaul transmission based on policy criteria, code for directing the received signal by diverting the received signal to the selected transceiver in response to a determination that the received signal is a message beacon signal, and code for transmitting a message beacon backhaul transmission to an external device using the selected RAT.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 generally illustrates a wireless communications environment in accordance with an aspect of the disclosure.

FIG. 2 generally illustrates a prior art wireless device interacting in the wireless communications environment of FIG. 1.

FIG. 3 generally illustrates a wireless device interacting in the wireless communications environment of FIG. 1 in accordance with an aspect of the disclosure.

FIG. 4 generally illustrates examples of wireless devices in accordance with an aspect of the disclosure.

FIG. 5 generally illustrates a communication device that includes logic configured to perform functionality in accordance with an aspect of the disclosure.

FIG. 6 generally illustrates a flow diagram for processing a message beacon in accordance with an aspect of the disclosure.

FIG. 7 generally illustrates a flow diagram for receiving and diverting a message beacon at a first transceiver in accordance with an aspect of the disclosure.

FIG. 8 generally illustrates a flow diagram for receiving a message beacon receipt and selecting a transceiver for message beacon backhaul transmission at a connectivity engine in accordance with an aspect of the disclosure.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention. The words “exemplary” and/or “example” are used herein to mean “serving as an example, instance, or illustration.” Any embodiment described herein as “exemplary” and/or “example” is not necessarily to be construed as preferred or advantageous over other embodiments Likewise, the term “embodiments of the invention” does not require that all embodiments of the invention include the discussed feature, advantage or mode of operation. Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A wireless device may be mobile or stationary, and may communicate with a radio access network (RAN). As used herein, the term “wireless device” may be referred to interchangeably as an “access terminal” or “AT”, a “wireless device”, a “subscriber device”, a “subscriber terminal”, a “subscriber station”, a “user equipment” or UE, a “user terminal” or UT, a “mobile terminal”, a “mobile station” and variations thereof. Generally, wireless devices can communicate with a core network via the RAN, and through the core network the wireless devices can be connected with external networks such as the Internet. Of course, other mechanisms of connecting to the core network and/or the Internet are also possible for the wireless devices, such as over wired access networks, Wi-Fi networks (e.g., based on IEEE 802.11, etc.) and so on. Wireless devices can be embodied by any of a number of types of devices including but not limited to PC cards, compact flash devices, external or internal modems, wireless or wireline phones or tablets, and so on. A communication link through which wireless devices can send signals to the RAN is called an uplink channel (e.g., a reverse traffic channel, a reverse control channel, an access channel, etc.). A communication link through which the RAN can send signals to wireless devices is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

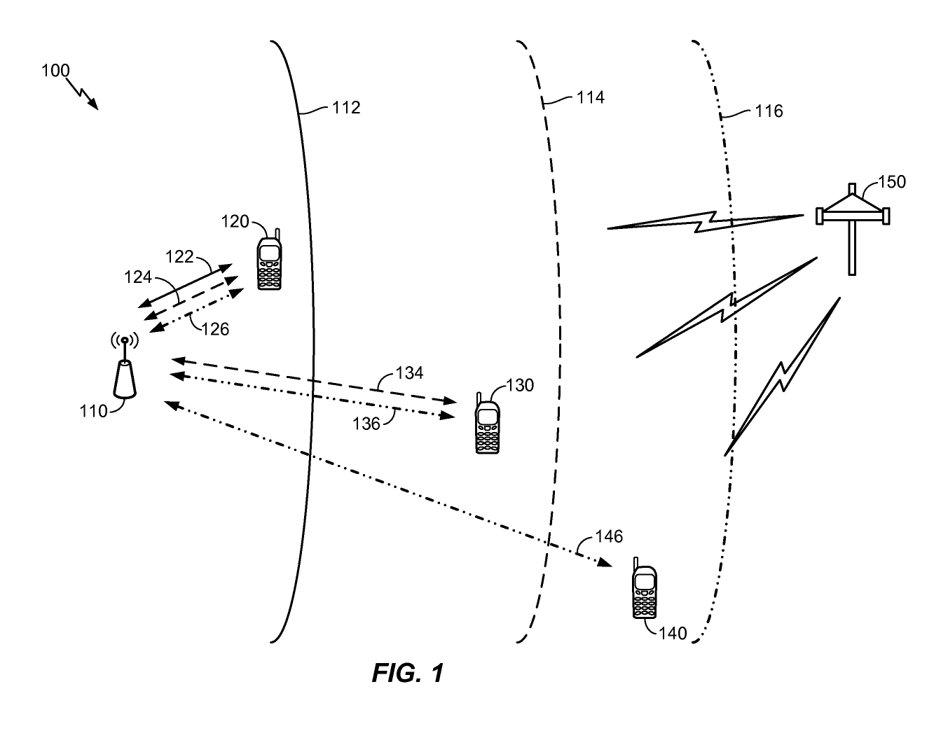

FIG. 1 illustrates a wireless communications environment 100 in accordance with an aspect of the disclosure. The wireless communications environment 100 includes a message beacon device 110, a plurality of wireless devices 120, 130, 140, and a backhaul network 150.

The message beacon device 110 includes a plurality of transceivers. In the example illustration of FIG. 1, the message beacon device 110 includes three different transceivers, each associated with a different radio access technology (RAT). However, it will be understood that aspects of the disclosure can be implemented in a message beacon device 110 having any number of transceivers associated with any number of RATs.

In FIG. 1, each of the three transceivers has a different range. The first transceiver has a first range 112 (shown as a solid line), the second transceiver has a second range 114 (shown as a dashed line), and the third transceiver has a third range 116 (shown as a dashed and dotted line). The respective ranges of each transceiver may be a function of any number of factors, including, for example, the RAT associated with the transceiver, the power associated with the transmissions of the transceiver, the topography of the wireless communications environment 100, etc. In one possible implementation, the first transceiver having first range 112 is a Bluetooth transceiver, the second transceiver having second range 114 is a WiFi transceiver, and the third transceiver having third range 116 is a LTE transceiver. For example, the first range 112 may be on the order of approximately ten meters, the second range 114 may be on the order of approximately thirty meters, and the third range may be on the order of approximately five hundred meters. Although each of the three transceivers in FIG. 1 is depicted as having a different range, it will be understood that different transceivers can have equal range.

The message beacon device 110 is configured to establish P2P links with wireless devices. The P2P links can be established using known techniques. The message beacon device 110 can establish a P2P link using the first transceiver, second transceiver, and/or the third transceiver. In order for the message beacon device 110 to establish a P2P link with a given wireless device, the given wireless device must be equipped with at least one transceiver that corresponds to one of the transceivers in the message beacon device 110, and must also be within the range associated of that transceiver. Once a P2P link is established, the message beacon device 110 may provide public information such as, for example, advertisements, public service information, etc.

FIG. 1 depicts several wireless devices 120, 130, 140, each of which is within one or more of the ranges 112, 114, 116 and equipped with one or more corresponding transceivers. Although each of the wireless devices 120, 130, 140 is depicted as a cell phone, it will be understood that the wireless devices 120, 130, 140 may be any device that is capable of wireless communication with the message beacon device 110.

The wireless device 120 depicted in FIG. 1 is equipped with three different transceivers corresponding to the three different transceivers included in the message beacon device 110. In addition, the wireless device 120 is also within each of the respective ranges 112, 114, 116 associated with the three different transceivers included in the message beacon device 110. As a result, a P2P link can be established between the message beacon device 110 and the wireless device 120 using any of the three different transceivers included in the message beacon device 110. Accordingly, FIG. 1 shows a first P2P link 122 (shown as a solid line) between the message beacon device 110 and wireless device 120, as well as a second P2P link 124 (shown as a dashed line) and a third P2P link 126 (shown as a dashed and dotted line).

The wireless device 130 depicted in FIG. 1 is within the second range 114 and third range 116 associated with the second and third transceivers of the message beacon device 110, respectively. However, the wireless device 140 is not within the first range 112 associated with the first transceiver. As a result, the message beacon device 110 cannot establish a P2P link between the message beacon device 110 and the wireless device 140 using the first transceiver (regardless of whether the wireless device 140 is in fact equipped with a corresponding transceiver). However, in FIG. 1, the wireless device 140 is equipped with a transceiver that corresponds to the second transceiver and a transceiver that corresponds to the third transceiver. Accordingly, FIG. 1 does not show a first P2P link analogous to first P2P link 122, but does show a second P2P link 134 (shown as a dashed line) between the message beacon device 110 and wireless device 130 as well as a third P2P link 136 (shown as a dashed and dotted line).

The wireless device 140 is not within wither the first range 112 or the second range 114. However, the wireless device 140 is within the third range 116 and is equipped with a transceiver corresponding to the third transceiver included in the message beacon device 110. As a result, the message beacon device 110 can establish a third P2P link 146 (shown as a dashed and dotted line) between the message beacon device 110 and wireless device 140.

The backhaul network 150 is configured to wirelessly communicate with each of the wireless devices 120, 130, 140. Although FIG. 1 depicts the backhaul network 150 as a cell tower, it will be understood that a cell tower is not itself a backhaul network and merely represents one of many possible conduits through which the backhaul network 150 can be accessed by the wireless devices 120, 130, 140. In some scenarios, a third-party wireless device may act as an intermediary between the wireless devices 120, 130, 140 and the backhaul network 150. For example, the third-party wireless device may receive a message beacon, send a backhaul transmission, receive data related to the received message beacon, and then forward the received data to one of the wireless devices 120, 130, 140.

The wireless devices 120, 130, 140 are configured to communicate with the backhaul network 150 via any suitable communication protocol using any suitable transceiver. Suitable communication protocols may include (but are not limited to) Third Generation Partnership Project (3GPP) protocols, WiFi protocols, Long Term Evolution (LTE) protocols, etc. Suitable transceivers may include (but are not limited to) wireless local area network (WLAN) transceivers, wireless wide area network (WWAN), WiFi transceivers, LTE transceivers, etc. The particular transceiver or transceivers used by the wireless devices 120, 130, 140 to communicate with the backhaul network 150 may be the same as or different from the transceiver(s) used to receive message beacons from the message beacon device 110.

In accordance with an aspect of the invention, a message beacon is received by one or more of the wireless devices 120, 130, 140. Although the following example will be described as if it involves wireless device 120, it will be understood that it may involve any (or all) any of the wireless devices 120, 130, 140. The message beacon received by wireless device 120 may include, for example, a message beacon identifier that identifies the signal as a message beacon signal. The message beacon may contain a relatively small amount of data, and may include a certain amount of content that can be used immediately by the wireless device 120. However, that message beacon may also enable wireless device 120 to access specific content from an external device rather than from the message beacon itself.

In some scenarios, the content in the message beacon may be encrypted such that the content is only accessible if decrypted. The decryption may be enabled by a beacon service provider and transmitted to the wireless device 120 via secure communications. It may be possible, depending on the device manufacturer, that users may subscribe to one or more beacon services, which may have their own encryption policies and provisioning methodologies. Beacon- or vendor-specific encryption may also apply on the connection to the server, to preserve location or other data associated with the beacon service.

In some implementations, the wireless device 120 is configured to receive a message beacon from the message beacon device 110 and relay the message beacon to the external device via the backhaul network 150. Once the message beacon is relayed, the external device (for example, a server or other suitable device) can perform certain tasks that facilitate access. For example, the external server may identify specific content associated with the particular message beacon that was received from the message beacon device 110 and relayed by the wireless device 120. The external server may also determine whether to provide the identified content to the wireless device 120. In some implementations, the determination may be based on the preferences associated with a user of the wireless device, for example, an interest in certain types of messages (public service announcements, etc.) or certain types of content (promotional announcements, etc.), or a known affinity for certain message beacon sources (for example, if the message beacon is identified with a favorite vendor, etc.). Some users may indicate a preference for disregarding a large majority of the message beacons that are received, but others may wish to receive as much information as possible. In either case, the additional content may be selectively transmitted to the wireless device 120 by the external server. The transmission may occur via the aforementioned backhaul network 150, or may be completed via any other suitable means.

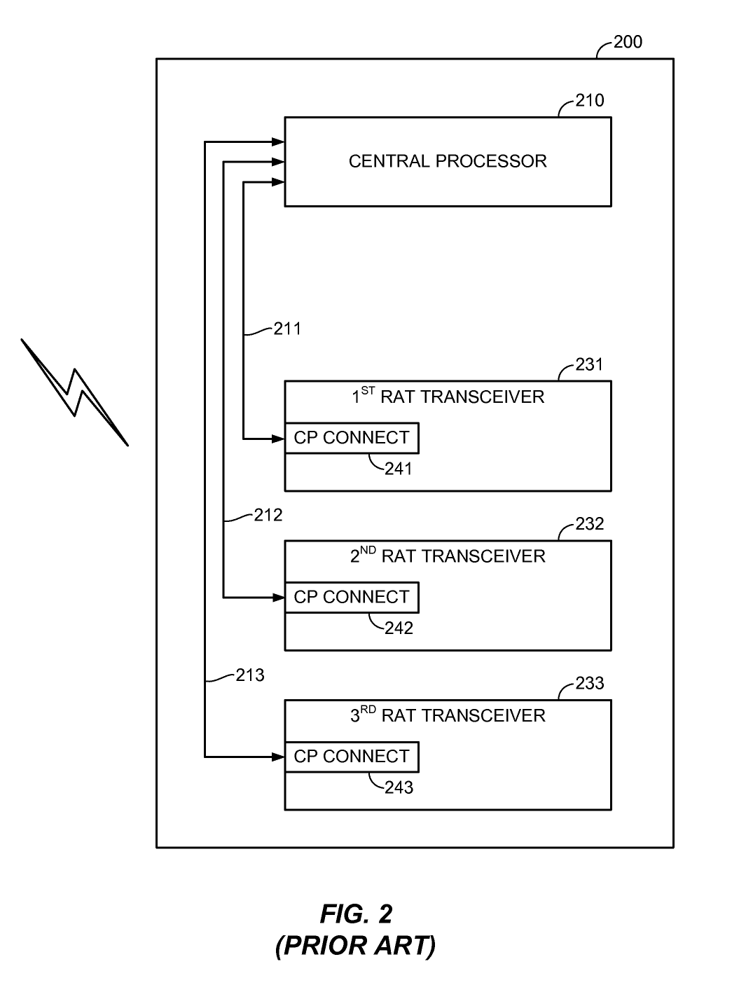

FIG. 2 generally illustrates a prior art wireless device 200. The prior art wireless device 200 may interact with the wireless communications environment 100 of FIG. 1 in the same manner as the wireless devices 120, 130, 140. In particular, the prior art wireless device 200 may communicate with the message beacon device 110 and the backhaul network 150. The messages that are communicated may include information related to various types of communication (e.g., voice, data, multimedia services, associated control signaling, etc.).

The prior art wireless device 200 may be variously configured for transmitting and encoding signals (e.g., messages, indications, information, and so on), and, conversely, for receiving and decoding signals (e.g., messages, indications, information, pilots, and so on) in accordance with the first RAT, second RAT, and third RAT. The prior art wireless device 200 may also include a central processor 210 for controlling operation of a first-RAT transceiver 231, a second-RAT transceiver 232, and a third-RAT transceiver 233 (e.g., directing, modifying, enabling, disabling, etc.). The transceivers 231, 232, 233 may operate at the direction of or otherwise in conjunction with respective host system functionality, for example, a high-level operating system (HLOS) stored on a memory component (not shown) associated with the central processor 210. The HLOS may be, for example, the Google Android operating system, Apple's iOS, or Microsoft's Windows Phone operating system.

The prior art wireless device 200 may operate over a communication medium of interest, composed of one or more frequency, time, and/or space communication resources (e.g., encompassing one or more channels across one or more carriers) associated with communication between one or more transmitter/receiver pairs. In general, the prior art wireless device 200, message beacon device 110 and backhaul network 150 may operate according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks have extended operation into unlicensed frequency bands such as the Unlicensed National Information Infrastructure (U-NII) band used by Wireless Local Area Network (WLAN) technologies, for example, IEEE 802.11 WLAN technologies generally referred to as “WiFi.”

As noted above, the prior art wireless device 200 includes three transceivers 231, 232, 233, each operating according to respective RATs. The transceivers 231, 232, 233 are co-located in the prior art wireless device 200. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a WiFi chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., USB, PCI express, an Ethernet switch) where the interface meets the latency requirements of any required inter-component communication (e.g., message). The first-RAT transceiver 231, second-RAT transceiver 232, and third-RAT transceiver may provide different functionalities and may be used for different purposes.

The prior art wireless device 200 may receive a message beacon via any of a plurality of transceivers 231, 232, 233 and then relay the message beacon to an external device using any of the plurality of transceivers 231, 232, 233. In order to do so, the message beacon is sent from the transceiver at which it is received to the central processor 210. Based on application or user preferences, the central processor 210 may notify the user of the prior art wireless device 200 that a message beacon has been received. As shown in FIG. 2, the first-RAT transceiver 231 includes a central processor connection 241 which communicates with the central processor 210 via a first transceiver connection 211. The second-RAT transceiver 232 and third-RAT transceiver 233 each include analogous central processor connections 242, 243 which communicate with the central processor 210 via a second transceiver connection 212 and a third transceiver connection 213, respectively.

The central processor 210, operating in accordance with a high-level operating system (HLOS) stored on an associated memory component (not shown), selects one of the plurality of transceivers 231, 232, 233 to relay the message beacon to the backhaul network 150. Once a transceiver is selected, the central processor 210 sends the message beacon to the selected transceiver via one of the transceiver connections 211, 212, 213. When the selected transceiver receives the message beacon at one of the central processor connections 241, 242, 243, it completes the relay by transmitting the message beacon to the external device (via, for example, the backhaul network 150 depicted in FIG. 1).

Although the prior art wireless device 200 completes the task of relaying the message beacon, a problem arises when the prior art wireless device 200 receives increasing numbers of message beacons. In particular, the central processor 210 needs to process each message beacon by, for example, recognizing each received signal as a message beacon, selecting a transceiver for completing the relay, and sending the message beacon to the selected transceiver. In some cases, these tasks require the processor to operate in accordance with the HLOS and/or ‘wake up’ by, for example, shifting from a low-power mode to a high-power mode. As a result, the task of constantly relaying a large number of message beacons to an external device can significantly impact the performance of the prior art wireless device 200. Accordingly, new solutions are needed to improve message beacon processing.

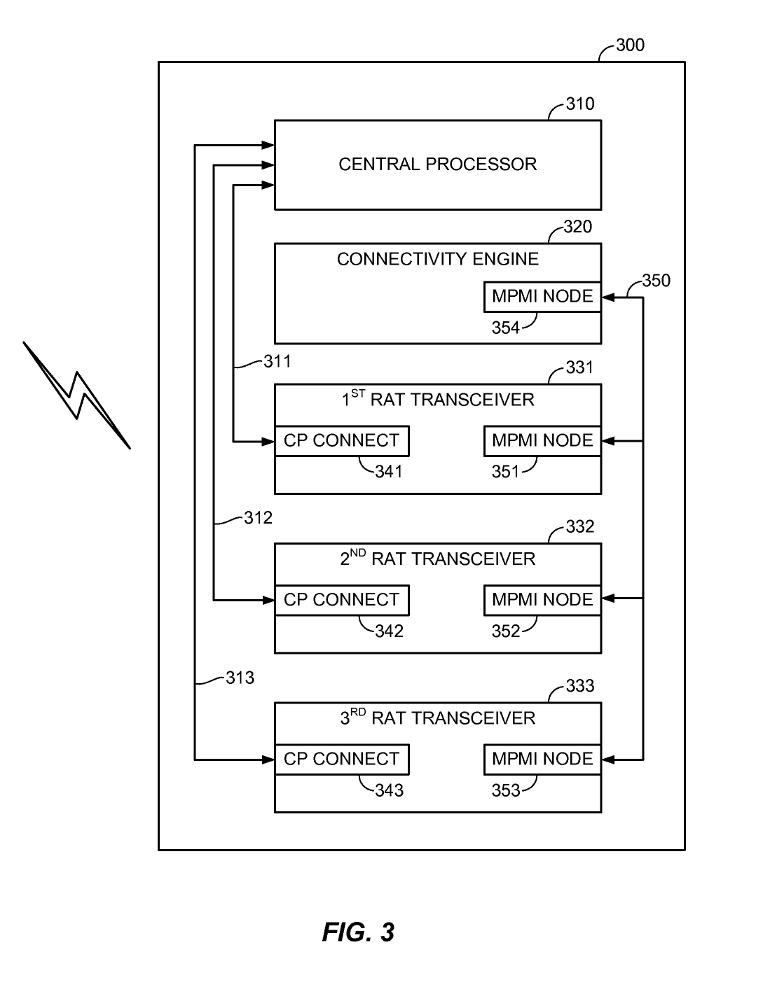

FIG. 3 generally illustrates a wireless device 300 in accordance with an aspect of the disclosure. The wireless device 300 may interact with the wireless communications environment 100 of FIG. 1 in substantially the same manner as the wireless devices 120, 130, 140. In particular, the wireless device 300 may communicate with the message beacon device 110 and the backhaul network 150. The messages that are communicated may include information related to various types of communication (e.g., voice, data, multimedia services, associated control signaling, etc.).

Like the prior art wireless device 200, the wireless device 300 may be variously configured for transmitting and encoding signals (e.g., messages, indications, information, and so on), and, conversely, for receiving and decoding signals (e.g., messages, indications, information, pilots, and so on). The wireless device 300 may also include a central processor 310 for controlling operation of a first transceiver 331, a second transceiver 332, and a third transceiver 333 (e.g., directing, modifying, enabling, disabling, etc.). The transceivers 331, 332, 333 may operate at the direction of or otherwise in conjunction with respective host system functionality, for example, a high-level operating system (HLOS) stored on a memory component (not shown) associated with the central processor 310. The transceivers 331, 332, 333 may operate in accordance with different RATs, or may be distinguishable in accordance with other characteristics.

Like the prior art wireless device 200, the wireless device 300 may operate over a communication medium of interest, composed of one or more frequency, time, and/or space communication resources (e.g., encompassing one or more channels across one or more carriers) associated with communication between one or more transmitter/receiver pairs. In general, the wireless device 300, message beacon device 110 and backhaul network 150 may operate according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks have extended operation into unlicensed frequency bands such as the Unlicensed National Information Infrastructure (U-NII) band used by Wireless Local Area Network (WLAN) technologies, for example, IEEE 802.11 WLAN technologies generally referred to as “WiFi.”

Like the prior art wireless device 200, the wireless device 300 includes three transceivers 331, 332, 333, each operating according to respective RATs. The transceivers 331, 332, 333 are co-located in the wireless device 300. Transceivers 331, 332, 333 may provide different functionalities and may be used for different purposes. As an example, the first transceiver 331 may operate in accordance with Bluetooth technology, the second transceiver 332 may operate in accordance with WiFi technology, and the third transceiver 333 may operate in accordance with Long Term Evolution (LTE) technology. Although only three transceivers are shown, it will be understood that the wireless device 300 may be equipped with any number of transceivers operating in accordance with any number of RATs. Although the transceivers 331, 332, 333 may have similar functionality as the transceivers 231, 232, 233 depicted in FIG. 2, the transceivers 331, 332, 333 may have additional functionality as set forth in the present disclosure. This additional functionality may be performed using, for example, a processor and memory (not shown) associated with the respective transceiver.

In accordance with an aspect of the disclosure, the wireless device 300 (by contrast to the prior art wireless device 200) further includes a connectivity engine 320. The connectivity engine 320 is configured to perform some of the tasks performed by the central processor 210 depicted in FIG. 2, in particular, controlling operation of transceivers 331, 332, 333 (e.g., directing, modifying, enabling, disabling, etc.). The connectivity engine 320 is also configured to select a particular transceiver for any given transmission. Like the central processor 310, the connectivity engine 320 includes a processor and memory (not shown). However, because the connectivity engine 320 is specially configured for controlling transceiver operations, it can therefore perform these tasks faster and/or more efficiently than the central processor 310. Although FIG. 3 depicts the connectivity engine 320 as being independent from the transceivers 331, 332, 333, it will be understood that other implementations are possible. For example, if any of the transceivers 331, 332, 333 includes an independent processor and memory, the connectivity engine 320 may reside on the transceiver and be implemented using the independent processor and memory. As another example, the connectivity engine 320 may be driven by a hardware state machine.

The connectivity engine 320 may identify a particular default transceiver for transmission, and may modify its selection on the basis of, for example, the transmission to be performed, the capabilities of each transceiver, the characteristics of the wireless device generally, and/or the characteristics of the surrounding wireless environment. As particular examples, the connectivity engine 320 may select a particular transceiver on the basis of the type of signal or amount of data being transmitted, the urgency of the transmission, a quality of service requirement associated with the transmission, the type or quality of links available, the data rate associated with each particular RAT, a consumption cost associated with each particular RAT, an amount of resources available to the wireless device, a particular geographic zone in which the wireless device is located, the time of day, the coexistence impact of a particular transceiver (i.e., interference with other communications using other transceivers), etc. The connectivity engine 320 may also be configured to ascertain the characteristics of the surrounding wireless environment by, for example, controlling the transceivers to perform measurements and/or configured to follow control commands received from an external controller (access point, base station, etc.).

Because the connectivity engine 320 is specially configured for controlling transceiver operations, it can perform these tasks faster and/or more efficiently than the central processor 310. When the wireless device 300 needs to perform these tasks, it can do so while the central processor 310 remains in a low-power mode, without requiring any operations to be performed in accordance with the HLOS. As a result, the wireless device 300 operates more efficiently than the prior art wireless device 200 depicted in FIG. 2.

In accordance with an aspect of the disclosure, the wireless device 300 (by contrast to the prior art wireless device 200) further includes a multi-point messaging interface (MPMI) 350. The connectivity engine 320 can use the MPMI 350 to communicate directly with the transceivers 331, 332, 333, with which it is directly coupled. The transceivers 331, 332, 333 are respectively equipped with MPMI nodes 351, 352, 353, and the connectivity engine 320 is equipped with an MPMI node 354. Because the connectivity engine 320 can communicate directly with the transceivers 331, 332, 333 via the MPMI 350, it can do so while the central processor 310 remains in a low-power mode, without requiring any operations to be performed by the central processor 310 in accordance with the HLOS. As will be discussed in greater detail below, the MPMI 350 also enables the respective transceivers 331, 332, 333 to communicate with one another directly. Because the transceivers can bypass the central processor 310 when communicating with one another (without requiring the central processor 310 to perform any operations in accordance with the HLOS), the wireless device 300 operates more efficiently than the prior art wireless device 200 depicted in FIG. 2. By bypassing the central processor 310 and avoiding operations in accordance with the HLOS, speed may be increased and resources may be conserved.

The MPMI node may include hardware similar to other bus interfaces, but may further include a configuration register in each MPMI node that configures its operation. Configuration may be done by, for example, the central processor 310. The function of the MPMI node in each subsystem is to enable peer to peer communications between any other MPMI node, for the purpose of exchanging control plane messages amongst subsystems. A unique aspect of the MPMI 350 is that each MPMI node can operate in a master or slave mode. For example, in a master mode, any of the MPMI nodes 351-355 may gain control of the bus as a master to send data, while the others operate in a slave mode to receive data. The MPMI node configuration includes a priority setting that enables each MPMI node to determine its priority during the bus arbitration phase (i.e., determining which of the MPMI nodes 351-355 is to operate in a master mode). Once another of the MPMI nodes 351-355 gains control of the bus, the previous master MPMI node transitions to a slave mode.

In the scenario described herein, the connectivity engine 320 may be given the highest priority in that its core function is to determine and enable the optimal routing from a transceiver at which a message beacon is received to a transceiver that is selected for backhaul transmission. The connectivity engine 320 may also determine the best backhaul connection to engage with Internet connectivity to receive messages or data relevant to the uploaded message beacon.

As depicted in FIG. 3, the MPMI 350 also connects to the central processor 310. The MPMI 350 may connect via MPMI node 355. As noted above, the central processor 310 can be bypassed when higher-level processing is unnecessary. However, it will be understood that when one or more tasks does involve higher-level processing, the MPMI 350 can be used for communications between the central processor 310 and one or more of the connectivity engine 320 and/or transceivers 331, 332, 333. For example, the central processor 310 may be bypassed relaying a received message beacon to an Internet backhaul, but the return signal from the Internet may be sent directly to the central processor 310. The central processor 310 may configure (via, for example, the MPMI 350) the connectivity engine 320 to perform different actions on subsequent message beacons (changing the default backhaul transceiver etc.).

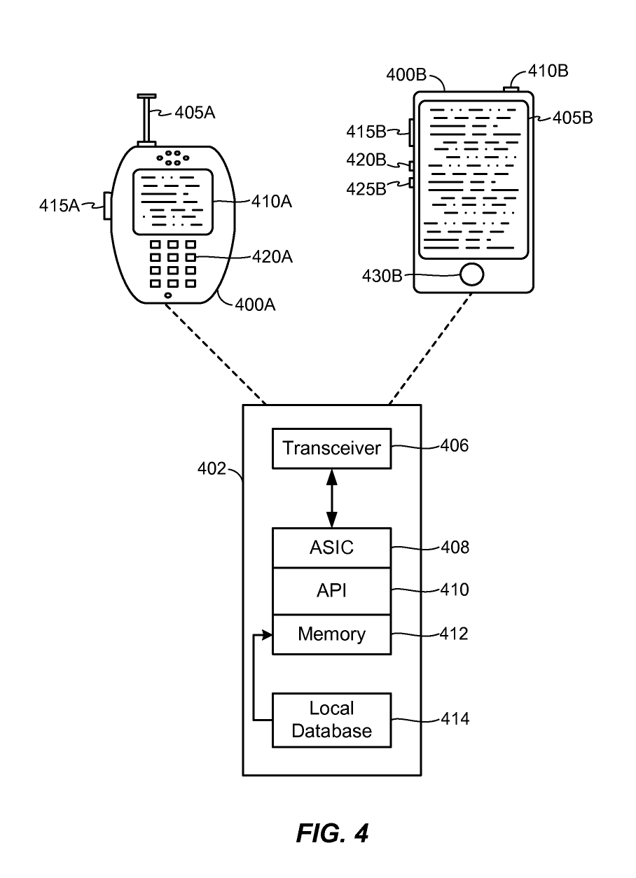

FIG. 4 illustrates examples of wireless devices in accordance with various aspects of the disclosure. Referring to FIG. 4, wireless device 400A is illustrated as a calling telephone and wireless device 400B is illustrated as a touchscreen device (e.g., a smart phone, a tablet computer, etc.). As shown in FIG. 4, an external casing of wireless device 400A is configured with an antenna 405A, display 410A, at least one button 415A (e.g., a PTT button, a power button, a volume control button, etc.) and a keypad 420A among other components, as is known in the art. Also, an external casing of wireless device 400B is configured with a touchscreen display 405B, peripheral buttons 410B, 415B, 420B and 425B (e.g., a power control button, a volume or vibrate control button, an airplane mode toggle button, etc.), at least one front-panel button 430B (e.g., a Home button, etc.), among other components, as is known in the art. Each of wireless device 400A and wireless device 400B includes one or more user interface components through which a user of the wireless device 400A or wireless device 400B interacts with the device, for example, button 415A, touchscreen display 405B, etc. The user of the wireless device 400A or wireless device 400B can provide input or instructions to the device via one or more of the user interface components, and the device can provide output or notifications to the user via one or more of the user interface components. While not shown explicitly as part of wireless device 400B, the wireless device 400B can include one or more external antennas and/or one or more integrated antennas that are built into the external casing of wireless device 400B, including but not limited to Wi-Fi antennas, cellular antennas, satellite position system (SPS) antennas (e.g., global positioning system (GPS) antennas), and so on.

While internal components of wireless devices such as the wireless devices 400A and 400B can be embodied with different hardware configurations, a basic high-level wireless device configuration for internal hardware components is shown as platform 402 in FIG. 4. The platform 402 can receive and execute software applications, data and/or commands transmitted from a radio access network, internet, and/or remote servers and networks. The platform 402 can also independently execute locally stored applications without RAN interaction. The platform 402 can include a transceiver 406 operably coupled to an application specific integrated circuit (ASIC) 408, or other processor, microprocessor, logic circuit, or other data processing device. The ASIC 408 or other processor executes the application programming interface (API) 410 layer that interfaces with any resident programs in the memory 412 of the wireless device. The memory 412 can be comprised of read-only or random-access memory (RAM and ROM), EEPROM, flash cards, or any memory common to computer platforms. The platform 402 also can include a local database 414 that can store applications not actively used in memory 412, as well as other data. The local database 414 is typically a flash memory cell, but can be any secondary storage device as known in the art, such as magnetic media, EEPROM, optical media, tape, soft or hard disk, or the like.

Accordingly, an embodiment of the invention can include a wireless device (e.g., wireless device 400A, 400B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 408, memory 412, API 410 and local database 414 may all be used cooperatively to load, store and execute the various functions disclosed herein and thus the logic to perform these functions may be distributed over various elements. Alternatively, the functionality could be incorporated into one discrete component. Therefore, the features of the wireless devices 400A and 400B in FIG. 4 are to be considered merely illustrative and the invention is not limited to the illustrated features or arrangement.

The wireless communication between the wireless devices 400A and/or 400B and other devices can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the wireless devices from the radio access network using a variety of networks and configurations. Accordingly, the illustrations provided herein are not intended to limit the embodiments of the invention and are merely to aid in the description of aspects of embodiments of the invention.

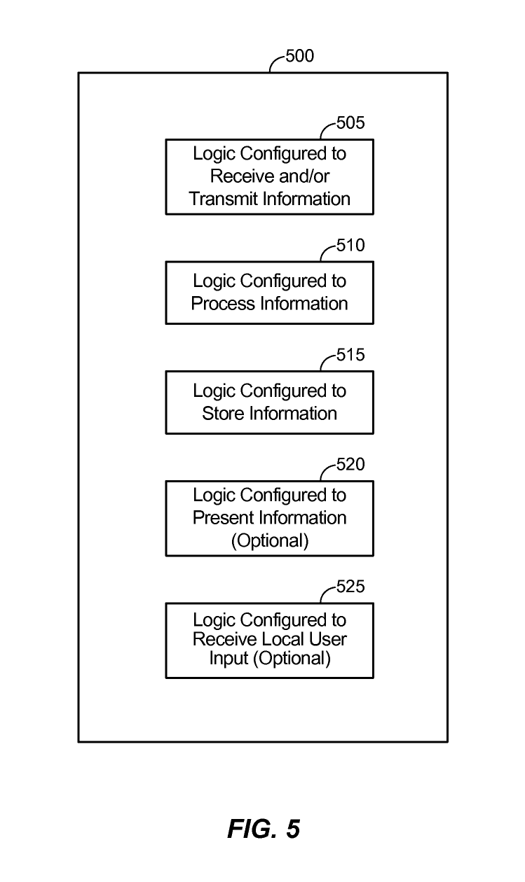

FIG. 5 illustrates a communication device 500 that includes logic configured to perform functionality. The communication device 500 can correspond to any of the above-noted communication devices, including but not limited to message beacon device 110, wireless devices 120, 130, 140, wireless device 300, wireless devices 400A or 400B, and so on.

Referring to FIG. 5, the communication device 500 includes logic configured to receive and/or transmit information 505. In an example, if the communication device 500 corresponds to a wireless communications device, the logic configured to receive and/or transmit information 505 can include a wireless communications interface (e.g., Bluetooth, Wi-Fi, 2G, CDMA, W-CDMA, 4G, 5G, LTE, etc.) such as a wireless transceiver and associated hardware (e.g., an RF antenna, a MODEM, a modulator and/or demodulator, etc.). In another example, the logic configured to receive and/or transmit information 505 can correspond to a wired communications interface (e.g., a serial connection, a USB or Firewire connection, an Ethernet connection through which the internet can be accessed, etc.). Thus, if the communication device 500 corresponds to some type of network-based server (e.g., PDSN, SGSN, GGSN, S-GW, P-GW, MME, HSS, PCRF, etc.), the logic configured to receive and/or transmit information 505 can correspond to an Ethernet card, in an example, that connects the network-based server to other communication entities via an Ethernet protocol. In a further example, the logic configured to receive and/or transmit information 505 can include sensory or measurement hardware by which the communication device 500 can monitor its local environment (e.g., an accelerometer, a temperature sensor, a light sensor, an antenna for monitoring local RF signals, etc.). The logic configured to receive and/or transmit information 505 can also include software that, when executed, permits the associated hardware of the logic configured to receive and/or transmit information 505 to perform its reception and/or transmission function(s). However, the logic configured to receive and/or transmit information 505 does not correspond to software alone, and the logic configured to receive and/or transmit information 505 relies at least in part upon hardware to achieve its functionality.

Referring to FIG. 5, the communication device 500 further includes logic configured to process information 510. In an example, the logic configured to process information 510 can include at least a processor. Example implementations of the type of processing that can be performed by the logic configured to process information 510 includes but is not limited to performing determinations, establishing connections, making selections between different information options, performing evaluations related to data, interacting with sensors coupled to the communication device 500 to perform measurement operations, converting information from one format to another (e.g., between different protocols such as .wmv to .avi, etc.), and so on. For example, the processor included in the logic configured to process information 510 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 510 can also include software that, when executed, permits the associated hardware of the logic configured to process information 510 to perform its processing function(s). However, the logic configured to process information 510 does not correspond to software alone, and the logic configured to process information 510 relies at least in part upon hardware to achieve its functionality.

Referring to FIG. 5, the communication device 500 further includes logic configured to store information 515. In an example, the logic configured to store information 515 can include at least a non-transitory memory and associated hardware (e.g., a memory controller, etc.). For example, the non-transitory memory included in the logic configured to store information 515 can correspond to RAM memory, flash memory, ROM memory, EPROM memory, EEPROM memory, registers, hard disk, a removable disk, a CD-ROM, or any other form of storage medium known in the art. The logic configured to store information 515 can also include software that, when executed, permits the associated hardware of the logic configured to store information 515 to perform its storage function(s). However, the logic configured to store information 515 does not correspond to software alone, and the logic configured to store information 515 relies at least in part upon hardware to achieve its functionality.

Referring to FIG. 5, the communication device 500 further optionally includes logic configured to present information 520. In an example, the logic configured to present information 520 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 500. For example, if the communication device 500 corresponds to wireless device 400A or wireless device 400B as shown in FIG. 4, the logic configured to present information 520 can include the display 410A of wireless device 400A or the touchscreen display 405B of wireless device 400B. In a further example, the logic configured to present information 520 can be omitted for certain communication devices, such as network communication devices that do not have a local user (e.g., network switches or routers, remote servers, etc.). The logic configured to present information 520 can also include software that, when executed, permits the associated hardware of the logic configured to present information 520 to perform its presentation function(s). However, the logic configured to present information 520 does not correspond to software alone, and the logic configured to present information 520 relies at least in part upon hardware to achieve its functionality.

Referring to FIG. 5, the communication device 500 further optionally includes logic configured to receive local user input 525. In an example, the logic configured to receive local user input 525 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 500. For example, if the communication device 500 corresponds to wireless device 400A or wireless device 400B as shown in FIG. 4, the logic configured to receive local user input 525 can include the keypad 420A, any of the buttons 415A or 410B through 425B, the touchscreen display 405B, etc. In a further example, the logic configured to receive local user input 525 can be omitted for certain communication devices, such as network communication devices that do not have a local user (e.g., network switches or routers, remote servers, etc.). The logic configured to receive local user input 525 can also include software that, when executed, permits the associated hardware of the logic configured to receive local user input 525 to perform its input reception function(s). However, the logic configured to receive local user input 525 does not correspond to software alone, and the logic configured to receive local user input 525 relies at least in part upon hardware to achieve its functionality.

Referring to FIG. 5, while the configured logics of 505 through 525 are shown as separate or distinct blocks in FIG. 5, it will be appreciated that the hardware and/or software by which the respective configured logic performs its functionality can overlap in part. For example, any software used to facilitate the functionality of the configured logics of 505 through 525 can be stored in the non-transitory memory associated with the logic configured to store information 515, such that the configured logics of 505 through 525 each performs their functionality (i.e., in this case, software execution) based in part upon the operation of software stored by the logic configured to store information 515. Likewise, hardware that is directly associated with one of the configured logics can be borrowed or used by other configured logics from time to time. For example, the processor of the logic configured to process information 510 can format data into an appropriate format before being transmitted by the logic configured to receive and/or transmit information 505, such that the logic configured to receive and/or transmit information 505 performs its functionality (i.e., in this case, transmission of data) based in part upon the operation of hardware (i.e., the processor) associated with the logic configured to process information 510.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

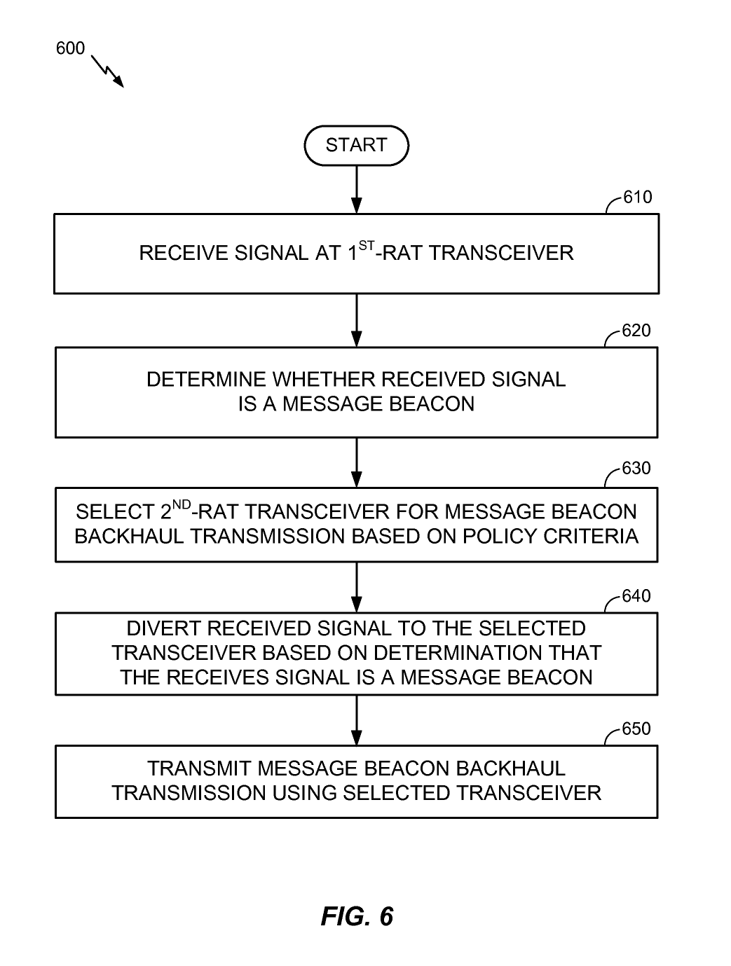

FIG. 6 generally illustrates a method 600 for processing a message beacon in accordance with an aspect of the disclosure. The method 600 may be performed by, for example, the wireless device 300 of FIG. 3, the wireless device 400A or wireless device 400B of FIG. 4, or the communication device 500 of FIG. 5. For the purposes of illustration, the method 600 will be described in further detail as it would be performed by the wireless device 300 of FIG. 3.

At 610, the wireless device 300 receives a signal at a first transceiver associated with a first RAT. In one possible implementation, the first transceiver is a Bluetooth transceiver that receives signals in accordance with a Bluetooth or Bluetooth Low Energy (BTLE) protocol (sometimes referred to as “Bluetooth Smart”). Because (in this implementation) the wireless device 300 is configured to operate in accordance with the BTLE protocol (and, in this example, proximate to the message beacon device 110), the wireless device 300 will receive the message beacon.

The signal reception at 610 may be performed by the radio frequency circuitry (antenna, etc.) included in the first transceiver 331. In some implementations, the first transceiver 331 may include a processor and associated memory component (independent from the central processor 310 and associated memory component) that are configured to perform some of the functions necessary to receive signals.

At 620, the wireless device 300 determines whether the signal received at 610 is a message beacon signal. The wireless device 300 will then determine based on, for example, a beacon identifier field of the received signal, that the signal received at 610 is a message beacon.

As noted above, any of the transceivers 331, 332, 333 may include an independent processor and memory configured to perform operations relating to the functions of the transceiver. It will be understood that in accordance with an aspect of the present disclosure, any of the transceivers 331, 332, 333 (or a combination of a processor and memory residing therein) may be further configured to distinguish message beacons from other types of received signals. As a result, the wireless device 300 can distinguish message beacons from other types of received signals while the central processor 310 remains in a low-power mode, without requiring any operations to be performed in accordance with the HLOS. As a result, the wireless device 300 operates more efficiently than the prior art wireless device 200 depicted in FIG. 2.

At 630, the wireless device 300 selects a second transceiver associated with a second RAT for message beacon backhaul transmission based on policy criteria. In particular, the connectivity engine 320 selects a particular transceiver from among a plurality of transceivers associated with the wireless device 300. In one possible implementation, the connectivity engine 320 selects a particular transceiver for all transmissions generally, or for all message beacon backhaul transmissions in particular (in view of respective capabilities of the plurality of transceivers, the characteristics of the wireless device, the characteristics of a surrounding wireless environment, etc.). For example, the connectivity engine 320 may determine that a particular transceiver lacks basic backhaul connectivity, as in a case where a WiFi transceiver lacks connectivity because there is no access point available, or because the access point requires a user log-in which has not been entered. As a result, the connectivity engine 320 may divert the message beacon to an LTE transceiver. In yet another possible implementation, the connectivity engine 320 selects a particular transceiver based on some particular characteristic of the message beacon received at 610 (for example, the transceiver that received the message beacon, a preferred transceiver indicated by the message beacon data itself, etc.).

Although the selection 630 is depicted in FIG. 3 as being performed after the determination of 620, it will be understood that the selection 630 may also be performed prior to the determination of 620 and/or prior to the reception of 610.

As noted above, the connectivity engine 320 is specially configured for controlling transceiver operations, and can perform the selection 630 faster and/or more efficiently than the central processor 310. When the wireless device 300 needs to perform these tasks, the connectivity engine 320 can do so while the central processor 310 remains in a low-power mode, without requiring any operations to be performed in accordance with the HLOS. As a result, the wireless device 300 operates more efficiently than the prior art wireless device 200 depicted in FIG. 2.

At 640, the wireless device 300 directs the signal received at 610 by diverting the received signal to the transceiver selected at 630. The diverting at 640 is responsive to the determination (at 620) that the received signal is a message beacon signal. The diverting may be performed using the MPMI 350.

In one possible implementation, a WLAN transceiver is selected (at 630) from among a plurality of transceivers (a WWAN transceiver, a Bluetooth transceiver, etc.). After the WLAN transceiver is selected, the wireless device diverts the message beacon to the WLAN transceiver. As noted above, the MPMI 350 enables the respective transceivers 331, 332, 333 to communicate with one another directly. The prior art wireless device 200, by contrast, would simply forward the received signal (regardless of whether it was a message beacon or not) to the central processor 210. Because the transceivers 331, 332, 333 can bypass the central processor 310 when communicating with one another (without requiring the central processor 310 to perform any operations in accordance with the HLOS), the wireless device 300 operates more efficiently than the prior art wireless device 200 depicted in FIG. 2.

At 650, the wireless device 300 transmits a message beacon backhaul transmission to an external device using the selected transceiver (of 630). In one possible implementation, a BTLE transceiver at which a message beacon is received at 610 diverts the message beacon (at 640) to a WLAN transceiver. The WLAN transceiver then transmits the message beacon to the external device (for example, an external server for processing message beacons) at 650.

As can be understood from the foregoing, the method 600 enables the wireless device 300 to process message beacons without any involvement of the central processor 310. Because the wireless device can bypass the central processor 310 when processing message beacons (without requiring the central processor 310 to perform any operations in accordance with the HLOS), the wireless device 300 operates more efficiently than the prior art wireless device 200 depicted in FIG. 2.

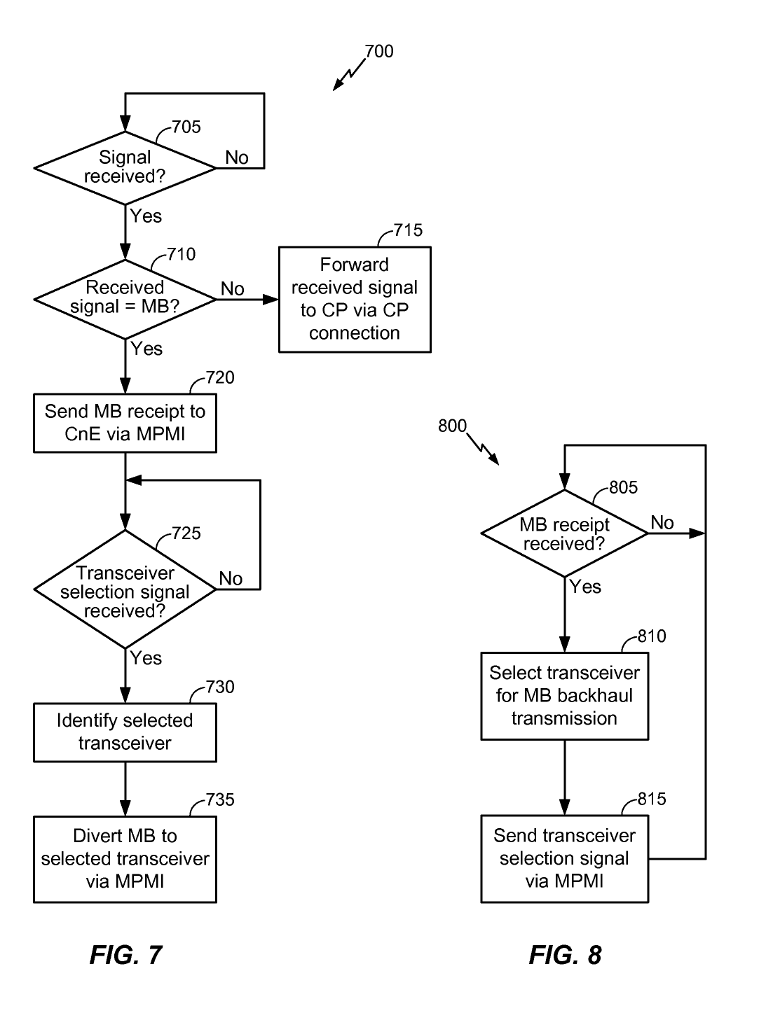

FIG. 7 generally illustrates a method 700 for processing received signals performed by a first transceiver, for example, any of the transceivers 331, 332, 333. For the purposes of illustration, the method 700 will be described in further detail as it would be performed by the first transceiver 331 depicted in FIG. 3. The method 700 may be performed by particular components of the first transceiver 331, an independent processor and memory associated with the first transceiver 331, hardware associated with the first transceiver 331, and/or a configurable state machine associated with the first transceiver 331. In some scenarios, the first transceiver 331 further includes hardware that is configured for processing of a specific beacon format. For example, if the first transceiver 331 is a Bluetooth transceiver, then the hardware may be configured to perform Bluetooth protocol decoding.

At 705, the first transceiver 331 determines whether a signal has been received. The method 700 continuously loops back to the determination 705 until a signal has been received, at which point the method 700 proceeds to 710. It will be understood that the first transceiver 331 (or a combination of a processor and memory component residing therein) may be configured to perform signal reception in accordance with known methods.

At 710, the first transceiver 331 determines whether the signal received at 705 is a message beacon. As noted above, the first transceiver 331 (or a combination of a processor and memory residing therein) may determine whether the received signal is a message beacon in accordance with any suitable method. Moreover, the first transceiver 331 performs the determination 710 independently without requiring the central processor 310 to perform any operations. In particular, the first transceiver 331 may, for example, read a message beacon identifier field of the received signal and determine, based on the content or existence of the message beacon identifier field, that the received signal is a message beacon. Although the data structure of a message beacon may vary in accordance with different RATs, it will be understood that a message beacon identifier field may comprise a bit or series of bits that identifies the received signal as a message beacon generally and/or identifies the received signal as a particular message beacon having a unique message beacon identification code.

If the first transceiver 331 determines that the received signal is not a message beacon, then the method 700 proceeds to 715, where the received signal is forwarded to the central processor 310. After the received signal is forwarded to the central processor 310 at 715, the method 700 ends, or alternatively, loops back to 705 (not shown).

On the other hand, if the first transceiver 331 determines that the received signal is a message beacon, then the method proceed to 720. At 720, the first transceiver 331 sends a message beacon receipt signal to a connectivity engine, for example, connectivity engine 320. As noted above, the message beacon receipt signal may be sent to the connectivity engine 320 via (for example) the MPMI 350 without requiring the central processor 310 to perform any operations.

As noted above, the connectivity engine 320 may be implemented using, for example, a processor and memory component (not shown) that are independent from the central processor 310 of the wireless device 300. For example, the independent processor and memory component of the connectivity engine 320 may not perform operations in accordance with the HLOS. As shown in FIG. 3, the first transceiver 331 includes an MPMI node 351 and can communicate directly with the connectivity engine 320 via the MPMI node 354 of the MPMI 350. Accordingly, the message beacon receipt sent at 720 may be sent directly from the first transceiver 331 to the connectivity engine 320 without requiring the central processor 310 to perform any operations in accordance with the HLOS.

At 725, the first transceiver 331 waits for a transceiver selection signal, for example, a transceiver selection signal from the connectivity engine 320. As will be discussed in greater detail below (FIG. 8), the connectivity engine 320 will reply to a message beacon receipt signal by sending a transceiver selection signal. As shown in FIG. 3, the connectivity engine 320 includes an MPMI node 354 and can communicate directly with the first transceiver 331 via the MPMI 350. Accordingly, the transceiver selection signal received at 725 may be received directly from the connectivity engine 320 without requiring the central processor 310 to perform any operations in accordance with the HLOS. Once the transceiver selection signal is received, the method 700 proceeds to 730.

In some scenarios, the connectivity engine 320 is implemented using the same components as the transceiver that received the message beacon (for example, the first transceiver 331). It will be understood that in these scenarios, it will be unnecessary to send the message beacon to the connectivity engine 320 using the MPMI 350 (as in 720), and it will also be unnecessary to wait to receive a transceiver selection signal from the connectivity engine (as in 725). Accordingly, the sending at 720 and receiving at 725 (both performed using the MPMI 350) may be omitted if the connectivity engine 320 and first transceiver 331 are implemented using the same component.

At 730, the first transceiver 331 identifies the selected transceiver based on the transceiver selection signal received at 725, which may include an indication of the selected transceiver. The identity of the selected transceiver may be, for example, encoded in the transceiver selection signal received at 725.

At 735, the first transceiver 331 diverts the signal received at 705 (which has been determined to be a message beacon at 710) to the transceiver identified at 730. As shown in FIG. 3, the first transceiver 331 includes an MPMI node 351 and can communicate directly with the other transceivers 332, 333 via the respective MPMI nodes 352, 353 of the MPMI 350. Accordingly, the diverted message beacon sent at 730 may be sent directly from the first transceiver 331 to the selected transceiver without requiring the central processor 310 to perform any operations in accordance with the HLOS.

In some scenarios, the transceiver selected for backhaul transmission will be the same as the transceiver that has received the message beacon. It will be understood that in these scenarios, the diversion 735 will be omitted, since the message beacon is already available to the transceiver selected for backhaul transmission.

FIG. 8 generally illustrates a method 800 for processing received signals performed by a connectivity engine such as, for example, the connectivity engine 320 depicted in FIG. 3.

At 805, the 320 determines whether a message beacon receipt has been received. The message beacon receipt signal received at 805 may be analogous to the message beacon receipt signal sent at 720 by the first transceiver 331. As shown in FIG. 3, the connectivity engine 320 includes an MPMI node 354 and can communicate directly with the transceivers 331, 332, 333 via the MPMI 350. Accordingly, the message beacon receipt received at 805 may be received directly from a transceiver without requiring the central processor 310 to perform any operations in accordance with the HLOS. It will be understood that the connectivity engine 320 may simultaneously monitor each of the transceivers 331, 332, 333 for message beacon receipts. The method 800 continuously loops back to the determination 805 until a message beacon receipt has been received, at which point the method 800 proceeds to 810.

At 810, the connectivity engine 320 selects a transceiver from among the plurality of transceivers 331, 332, 333 for performing the message beacon backhaul transmission. As noted above, the connectivity engine 320 is specially configured for controlling transceiver operations, and can perform the selection 810 faster and/or more efficiently than the central processor 310. When the wireless device 300 needs to perform these tasks, the connectivity engine 320 can do so while the central processor 310 remains in a low-power mode, without requiring any operations to be performed in accordance with the HLOS. As a result, the method 800 enables the wireless device 300 to operate more efficiently than the prior art wireless device 200 depicted in FIG. 2.

At 815, the connectivity engine 320 send a transceiver selection signal to the transceiver from which the message beacon receipt was received. The transceiver selection signal sent at 815 may be analogous to the transceiver selection signal received at 725 by the first transceiver 331. In particular, the transceiver selection signal identifies a particular transceiver selected to perform the transmission of a message beacon backhaul transmission associated with a received message beacon. As shown in FIG. 3, the connectivity engine 320 includes an MPMI node 354 and can communicate directly with the transceivers 331, 332, 333 via the MPMI 350. Accordingly, the transceiver selection signal sent at 815 may be sent directly to a transceiver without requiring the central processor 310 to perform any operations in accordance with the HLOS.

The transceiver selection signal sent at 815 may be sent via the MPMI 350 to the transceiver from which the message beacon receipt was received at 805. The transceiver selection signal sent at 815 may also be sent to the selected transceiver, for example, to notify the selected transceiver that it has been selected to receive a diverted message beacon signal via the MPMI 350 and/or command the selected transceiver to perform a message beacon backhaul transmission (via for example, the backhaul network 150 depicted in FIG. 1).

As shown in FIG. 3, the MPMI 350 may include a common interface that interconnects the connectivity engine 320 and each of the transceivers 331, 332, 333. Accordingly, the signals communicated via the MPMI 350 in accordance with the present disclosure (at 720, 725, 735, 805, 815, etc.) may be broadcast to every user of the MPMI 350. The signals communicated via the MPMI 350 may therefore include, in addition to the signal data itself, an indication of the intended recipient (or recipients) of the signal data. It will be understood, however, that other implementations of the MPMI 350 are possible and that the present disclosure is not limited to the common-interface arrangement depicted in FIG. 3. Additionally or alternatively, the MPMI 350 may provide dedicated connections between the connectivity engine 320 and each of the transceivers 331, 332, 333 and/or dedicated connections between each unique pair of transceivers.

As shown in FIG. 3, the connectivity engine 320 may be implemented independently from the central processor 310. For example, the connectivity engine 320 may be equipped with an independent processor and memory (not shown) such that the method 800 can be performed without any operations of the central processor 310. However, in another possible implementation, the connectivity engine 320 resides within one of the transceivers 331, 332, 333 such that the method 800 is performed by the processor and memory associated with the transceiver. As a result, the method 700 and method 800 may be implemented using a single processor operating in tandem with a single memory.

In an implementation where the method 700 and method 800 are performed using a single processor operating in tandem with a single memory, the sending and receiving of signals via the MPMI 350 (at 720, 725, 735, 805, 815, etc.) may constitute ‘sending’ and ‘receiving’ only in a conceptual sense. For example, data generated when performing the method 700 may be stored in the shared memory for later usage when the shared processor performs the method 800.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., wireless device). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A wireless device, comprising:
a first transceiver associated with a first radio access technology (RAT);
a second transceiver associated with a second RAT, wherein the second transceiver is configured to transmit a message beacon backhaul transmission to an external device; and
a connectivity engine configured to select the second transceiver for message beacon backhaul transmission based on policy criteria; wherein
the first transceiver is configured to:
receive a signal;
determine whether the received signal is a message beacon signal; and
direct the received signal by diverting the received signal to the selected transceiver in response to a determination that the received signal is a message beacon signal.

2. The wireless device of claim 1, wherein the first transceiver is configured to determine whether the received signal is a message beacon signal by determining whether the received signal includes a message beacon identifier.

3. The wireless device of claim 2, wherein the first transceiver is a Bluetooth transceiver associated with a Bluetooth RAT, and is further configured to:
receive a Bluetooth signal; and
determine whether the received Bluetooth signal includes a Bluetooth message beacon identifier.

4. The wireless device of claim 1, further comprising a central processor configured to operate in accordance with a high-level operating system;
wherein the first transceiver is further configured to direct the received signal by forwarding the received signal to a central processor in response to a determination that the signal is not a message beacon signal.

5. The wireless device of claim 1, further comprising:
a central processor configured to operate in accordance with a high-level operating system; and
a multi-point message interface (MPMI) configured to directly couple the first transceiver, the second transceiver, and the connectivity engine;
wherein the first transceiver is further configured to divert the received signal to the selected transceiver via the MPMI while bypassing the central processor and avoiding operations in accordance with the high-level operating system.

6. The wireless device of claim 1, wherein the first transceiver is further configured to send a message beacon receipt signal to the connectivity engine via a multi-point message interface (MPMI) in response to a determination that the received signal is a message beacon signal.

7. The wireless device of claim 6, wherein the connectivity engine is further configured to:
receive the message beacon receipt via the MPMI; and
send a transceiver selection signal to the first transceiver via the MPMI in response to the receiving of the message beacon receipt and the selecting of the second transceiver, wherein the transceiver selection signal includes an indication of the selected transceiver.

8. The wireless device of claim 7, wherein the first transceiver is further configured to:
receive the transceiver selection signal via the MPMI;
identify the selected transceiver based on the indication of the selected transceiver included in the received transceiver selection signal; and
send the message beacon signal to the selected transceiver indicated in the transceiver selection signal via the MPMI.

9. The wireless device of claim 1, wherein the connectivity engine is further configured to select the second transceiver based on one or more of:
respective capabilities of a plurality of transceivers associated with the wireless device;
characteristics of the wireless device; and
characteristics of a surrounding wireless environment.

10. The wireless device of claim 9, wherein the connectivity engine is further configured to perform the selecting without requiring a central processor to perform operations in accordance with a high-level operating system.

11. A method for processing a message beacon, comprising:
receiving a signal at a first transceiver associated with a first radio access technology (RAT);
determining whether the received signal is a message beacon signal;
selecting a second transceiver associated with a second RAT for message beacon backhaul transmission based on policy criteria;
directing the received signal by diverting the received signal to the selected transceiver in response to a determination that the received signal is a message beacon signal; and
transmitting a message beacon backhaul transmission to an external device using the selected transceiver.

12. The method of claim 11, wherein determining whether the received signal is a message beacon signal comprises determining whether the received signal includes a message beacon identifier.

13. The method of claim 12, wherein:
receiving the signal at a first transceiver comprises receiving the signal at a Bluetooth transceiver; and
determining whether the received signal includes a message beacon identifier comprises determining whether the received signal include a Bluetooth message beacon identifier.

14. The method of claim 11, wherein directing the received signal further comprises forwarding the received signal to a central processor in response to a determination that the signal is not a message beacon signal.

15. The method of claim 11, wherein diverting the received signal to the selected transceiver comprises bypassing a central processor and avoiding operations of the central processor in accordance with a high-level operating system by sending the received signal to the selected transceiver via a multi-point message interface (MPMI).

16. The method of claim 11, further comprising sending a message beacon receipt signal from the first transceiver to a connectivity engine via a multi-point message interface (MPMI) in response to a determination that the received signal is a message beacon signal.

17. The method of claim 16, further comprising:
receiving the message beacon receipt at the connectivity engine via the MPMI; and
sending a transceiver selection signal from the connectivity engine to the first transceiver via the MPMI in response to the receiving of the message beacon receipt and the selecting of the second transceiver, wherein the transceiver selection signal includes an indication of the selected transceiver.

18. The method of claim 17, wherein diverting the received signal to the selected transceiver comprises:
receiving the transceiver selection signal at the first transceiver via the MPMI;
identifying the selected transceiver based on the indication of the selected transceiver included in the received transceiver selection signal; and
sending the message beacon signal to the selected transceiver indicated in the transceiver selection signal via the MPMI.

19. The method of claim 11, wherein selecting the second transceiver based on policy criteria comprises selecting the second transceiver based on one or more of:
respective capabilities of a plurality of transceivers associated with a wireless device;
characteristics of the wireless device; and
characteristics of a surrounding wireless environment.

20. The method of claim 19, wherein the selecting is performed by a connectivity engine without requiring a central processor to perform operations in accordance with a high-level operating system.

21. An apparatus for improving processing of message beacons, comprising:
means for receiving a signal associated with a first radio access technology (RAT);
means for determining whether the received signal is a message beacon signal;
means for selecting a second RAT for message beacon backhaul transmission based on policy criteria;
means for directing the received signal by diverting the received signal to the selected transceiver in response to a determination that the received signal is a message beacon signal; and
means for transmitting a message beacon backhaul transmission to an external device using the selected RAT.

22. The apparatus of claim 21, wherein means for determining whether the received signal is a message beacon signal comprises means for determining whether the received signal includes a message beacon identifier.

23. The apparatus of claim 21, wherein means for directing the received signal further comprises means for forwarding the received signal to a central processor in response to a determination that the signal is not a message beacon signal.

24. The apparatus of claim 21, further comprising:
means for bypassing a central processor; and
means for avoiding operations of the central processor in accordance with a high-level operating system.

25. The apparatus of claim 21, wherein means for selecting the second transceiver based on policy criteria comprises means for selecting the second transceiver based on one or more of:
respective capabilities of a plurality of transceivers associated with a wireless device;
characteristics of the wireless device; and
characteristics of a surrounding wireless environment.

26. A computer-readable medium comprising code, which, when executed by a processor, causes the processor to perform operations for improving processing of message beacons, the non-transitory computer-readable medium comprising:
code for receiving a signal associated with a first radio access technology (RAT);
code for determining whether the received signal is a message beacon signal;
code for selecting a second RAT for message beacon backhaul transmission based on policy criteria;
code for directing the received signal by diverting the received signal to the selected transceiver in response to a determination that the received signal is a message beacon signal; and
code for transmitting a message beacon backhaul transmission to an external device using the selected RAT.

27. The apparatus of claim 26, wherein code for determining whether the received signal is a message beacon signal comprises code for determining whether the received signal includes a message beacon identifier.

28. The apparatus of claim 26, wherein code for directing the received signal further comprises code for forwarding the received signal to a central processor in response to a determination that the signal is not a message beacon signal.

29. The apparatus of claim 26, further comprising:
code for bypassing a central processor; and
code for avoiding operations of the central processor in accordance with a high-level operating system.

30. The apparatus of claim 26, wherein code for selecting the second transceiver based on policy criteria comprises code for selecting the second transceiver based on one or more of:
respective capabilities of a plurality of transceivers associated with a wireless device;
characteristics of the wireless device; and
characteristics of a surrounding wireless environment.
